(19) United States
(12) Patent Application Publication
(10) Pub. No.: US 2007/0143169 A1
(43) Pub. Date: Jun. 21, 2007

(54) Real-time workload information scheduling and tracking system and related methods

(76) Inventors: Chad W. Grant, Campbell, TX (US); Michelle R. Sales, Wills Point, TX (US); Ken A. Padilla, Campbell, TX (US); James C. Hayes, Sulphur Springs, TX (US); John R. Grant, Rockwall, TX (US); R. Keith Mabe, Greenville, TX (US); Gene C. Carista, Emory, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/314,329

(22) Filed: Dec. 21, 2005

(51) Int. Cl. G06F 15/02

(52) U.S. Cl. 705/9

(57) ABSTRACT

A real-time workload information scheduling and tracking system and related methods are disclosed that greatly facilitate production operations. Real-time views can be displayed at a variety of time period granularities (e.g., daily, weekly, monthly, quarterly, yearly, etc.) showing completion status for tasks and sub-tasks that have been assigned by the system to individual worker resources to accomplish all aspects of the production process. The processes are laid out in a series to allow so that project task priorities can be set and worked out in a specific order. A central location is also provided to document and track all schedule impacts, as well as quality notifications, held-for records, and discrepancy records written against the tasks or sub-tasks being displayed.

### TECHNICAL FIELD OF THE INVENTION

This invention relates to the management of production related projects that require a number of workers handling a variety of project tasks over an extended period of time.

### BACKGROUND

Many prior software solutions exist for project planning. These solutions provide a variety of techniques for specifying project tasks, identifying needed resources, and tracking the project progress. However, theses prior solutions do not adequately meet the needs for production related project management. In such an environment, there is still a need for a method to sequence work flow tasks and then to assign them to individual worker resources on a real-time basis. In addition, there is a need for the ability to document potential schedule impacts such as missing tools, problems with task definitions, labor and training issues, etc. And there is need to be able to see progress as tasks are completed in real-time. Prior attempts have been made to resolve these problems, such as manual, handwritten tracking logs. However, these manual activities are labor intensive and inaccurate. In short, there is need for a more efficient production project workload tracking and documentation system.

### SUMMARY OF THE INVENTION

The present invention provides a real-time workload information scheduling and tracking system and related methods that greatly facilitate production operations. Real-time views can be displayed, for example, at daily time period granularities showing completion status for tasks and sub-tasks that have been assigned by the system to individual worker resources to accomplish all aspects of the production process. In addition, a central location is provided to document and to track accurately and dynamically project status, as well as to track held-for and discrepancy records written against the tasks or sub-tasks being displayed.

In one embodiment, the present invention is a workload management system for production operations, including a database system configured to store data representing information relating to a plurality of tasks to be performed with respect to a production project and a plurality of worker resources available for completing the tasks where each task is configured to include a plurality of sub-tasks; one or more input mechanisms configured to receive feedback data concerning the production project including completion status information for sub-tasks, held-for information identifying one or more resources needed to complete a particular sub-task, and discrepancy report information identifying problems associated with a particular sub-task; and a server system coupled to the database and to the input mechanisms where the server system is configured to utilize data from the database system and feedback from the input mechanisms to display real-time status information for a relative completion level for each of the tasks based upon the completion status for the sub-tasks, to display a link to access held-for information, and to display a link to access discrepancy report information. As described below, other features and variations can be implemented, if desired, and related methods can be utilized, as well.

In another embodiment, the present invention is a method, including storing in a database system data representing information relating to a plurality of tasks to be performed with respect to a production project and a plurality of worker resources available for completing the tasks where each task being configured to include a plurality of sub-tasks; receiving feedback data concerning the production project including completion status information for sub-tasks, held-for information identifying one or more resources needed to complete a particular sub-task, and discrepancy report information identifying problems associated with a particular sub-task; and displaying real-time status information for a relative completion level for each of the tasks based upon the completion status for the sub-tasks, to display a link to access held-for information, and to display a link to access discrepancy report information. As described below, other features and variations can be implemented, if desired, and related systems can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block diagram of an example embodiment for a real-time workload tracking system according to the present invention.

FIG. 2 is a block diagram of an example embodiment for utilizing an enterprise operations database as part of the present invention.

FIG. 3 is a process flow diagram for updating database information as part of the real-time workload tracking system according to the present invention.

FIG. 4 is a process flow diagram for held-for record generation according to the present invention.

FIG. 5 is a process flow diagram for discrepancy record generation according to the present invention.

FIG. 6A is an example depiction for display information showing per-worker progress in completing a workload project.

FIG. 6B is an example depiction for display information showing status for sub-tasks within a given worker task.

### DETAILED DESCRIPTION OF THE INVENTION

The present invention provides a real-time workload information scheduling and tracking system and related methods that greatly facilitate production operations. The present invention combines the ability to schedule individual worker resources to accomplish all aspects of a production project with the ability to display a real-time view at a variety of time period granularities (e.g., daily, weekly, monthly, quarterly, yearly, etc.) of tasks and sub-tasks that have been assigned. The processes are laid out in a series to allow for project task priorities to be set and worked out in a specific order. The present invention also gives a central location to document and to track accurately and dynamically all schedule impacts, as well as track quality notifications, held-for records, and discrepancy records written against the tasks or sub-tasks being displayed. And additional process and training issues can be more easily identified, where these issues were difficult to identify by management previously.

In operation, the present invention provides significant workload tracking and management improvements. As discussed in more detail below, the present invention allows for display of the project schedule from start to finish on a daily basis (or other desired period of time) of tasks and sub-tasks to be completed by responsible individuals, allowing for training issues and potential process problems to be identified, collected, and responded to adequately. In addition, the present invention allows users (such as supervisors and workers) the ability to know whether or not they are on schedule in a near real-time manner. And scheduling can be accomplished by accessing data stored within an enterprise operations systems, such as SAP. In addition, graphical display of tasks and sub-tasks by the present invention provide goals for individual workers to work toward and allow workers to see their goals being accomplished by the progress markings and completion status information being displayed. The present invention also provides a means of tracking and documenting stops and/or set backs in work and corrective actions taken to bring work back up to schedule. In addition, offending departments can be automatically notified (e.g., through e-mail) with a time-constrained corrective action to facilitate a quicker response from the responsible department. In short, the present invention brings together many facets of data that relate to the tasks being performed into one central location thereby providing a project management tool for supervisors and managers that has complete project status information and that allows decisions to be made based on the most recent data available.

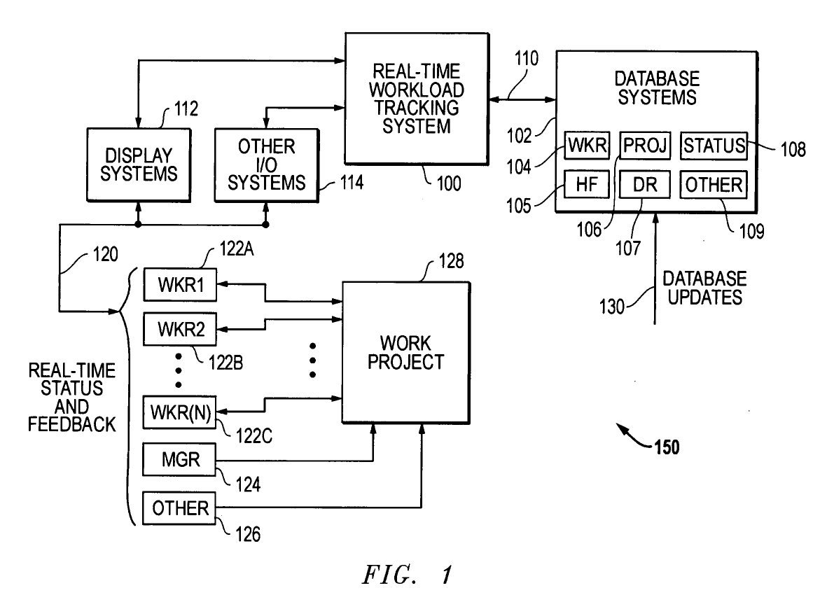

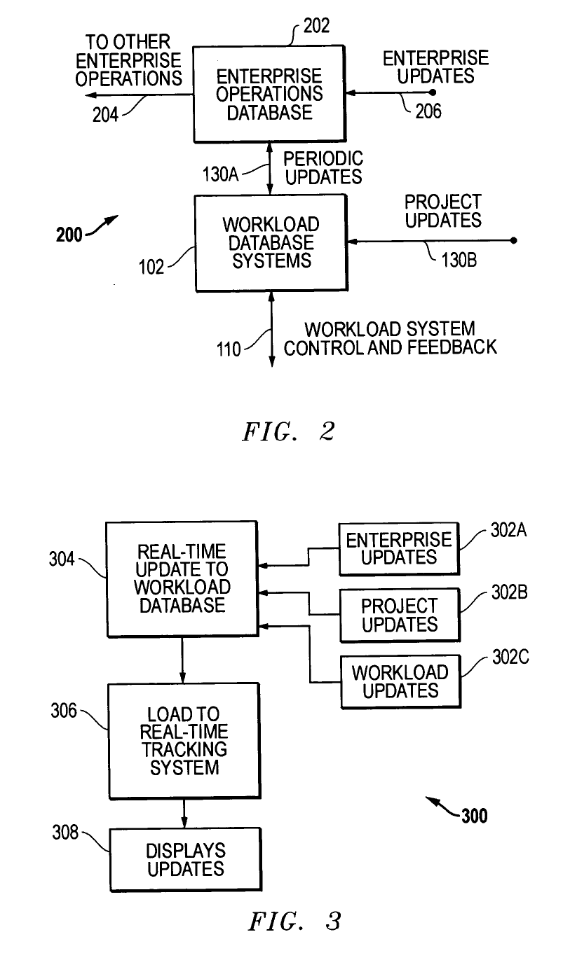

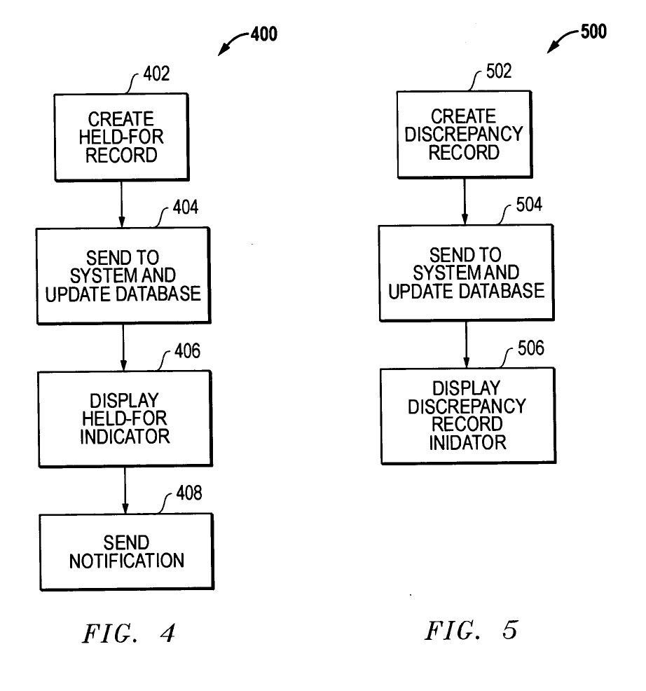

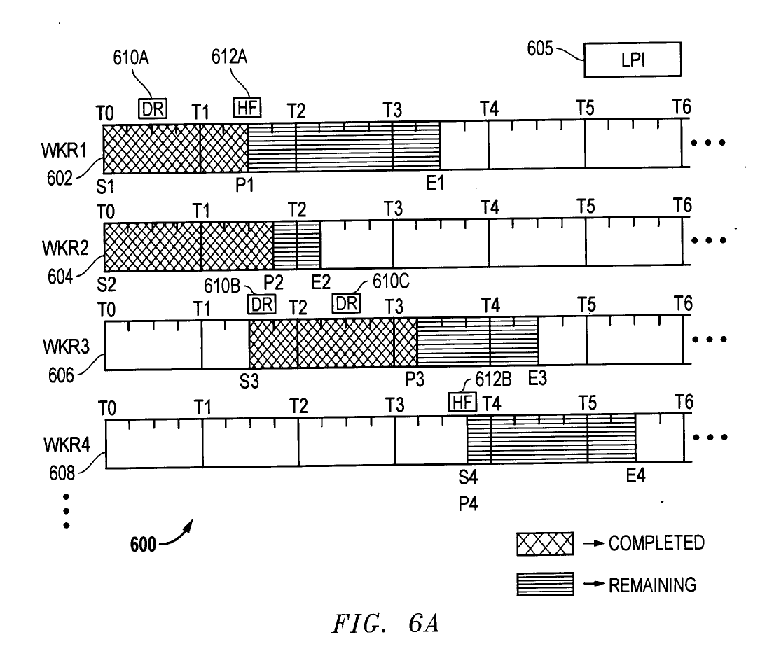

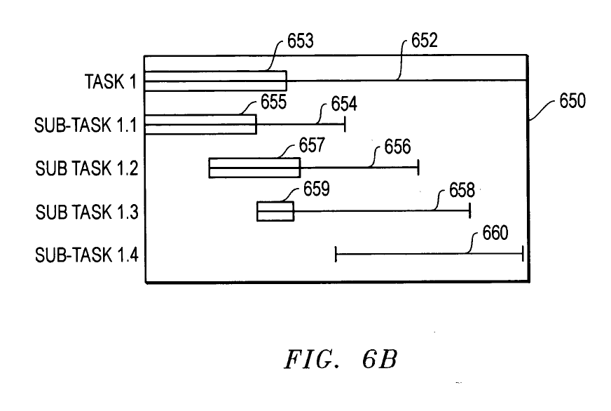

Example embodiments for the present invention will now be described with respect to the drawings. FIG. 1 is a block diagram of an example embodiment for a real-time workload tracking system. FIG. 2 is a block diagram of an example embodiment that utilizes an enterprise operations database as part of the present invention. FIG. 3 is a process flow diagram for updating database information. FIGS. 4 and 5 are process flow diagrams for held-for record and discrepancy record generation, respectively. FIG. 6A provides an example depiction of display information for per-worker progress information, and FIGS. 6B and 6C provide example depictions of display information showing status for sub-tasks within a given worker task or sub-task.

Looking now to FIG. 1, a block diagram is depicted of an example embodiment for a real-time workload tracking system environment 150 according to the present invention. As depicted, a work project 128 has tasks and sub-tasks that are being handled by a plurality of workers. The plurality of workers are represented as worker 1 (WKR1) 122A, worker 2 (WKR2) 2B . . . worker (N) (WKR(N)) 122C. In addition, one or more managers (MGR) 124 can be involved in monitoring work progress or working on the work project 128. As represented by element 126, other persons and/or groups can be involved as well.

The real-time workload tracking system 100 is connected to database systems 102, to display systems 112, and to other input/output (I/O) systems 114. The real-time workload tracking system 100 utilizes data within the database systems 102 and real-time workload status and feedback 120 to provide real-time workload tracking and status information. For example, the workers 122A, 122B . . . 122C can interact with display systems 112 or other input/output (I/O) systems 114, such as keyboards and pointing devices, to provide real-time feedback concerning their progress with respect to project tasks and sub-tasks. The real-time workload tracking system 100 can then provide graphical depictions of project status and workload progress through display systems 112. A manager (MGR) 124, workers 122A, 122B . . . 122C, or any other desired person can then use this visual display to quickly determine the status of the work project 128. And preferably, this visual display is provided at the site of the work project so that those involved can readily determine the status of the various tasks and sub-tasks being conducted for work project 128.

The database systems 102 can include a wide variety of data for use by the real-time workload tracking system 100. For example, employee or worker information can be stored as worker data records (WKR) 104. Project related information can be stored as project records (PROJ) 106. Status information can be stored as status records (STATUS) 108. Held-for information can be stored as held-for records (HF) 105. Discrepancies can be stored as discrepancy records (DR) 107. As indicated by element 109, other information can also be stored in data records, if desired. Element 130 represents database updates that can be made to the data within the database systems 102 during operation.

As depicted, therefore, workload management of production operations is provided by storing project workload related data in a database system and using this data to create worker schedules and track project status. The data in the database system represents information relating to tasks that are to be performed with respect to a production work project 128 and represents the worker resources 122A, 122B . . . 122C available for completing the tasks. In addition, each task can include a plurality of sub-tasks, and each sub-task can further include a plurality of sub-tasks, and so on. As the sub-tasks and tasks are completed by the workers 122A, 122B . . . 122C or as problems are encountered during work on the work project 128, feedback data concerning the production work project 128 is input into the system through display systems 112 or other I/O systems 114. This feedback information includes completion status information for sub-tasks, held-for information identifying one or more resources needed to complete a particular sub-task, and discrepancy report information identifying problems associated with a particular sub-task. The real-time workload tracking system 100 then displays real-time status information through display systems 112 for a relative completion level for each of the tasks based upon the completion status for the sub-tasks In addition, links to access held-for information and links to access discrepancy report information can also displayed. The work project 128 can be a wide variety of product projects. One example is aircraft maintenance projects where the tasks and sub-tasks to be completed represent job tickets for aircraft maintenance.

As indicated above, the database systems 102 can include a wide variety of desired project related data. Worker resources, for example, can identify a variety of details concerning individual workers and worker types. Preferably, the real-time workload tracking system is configured to utilize worker types in scheduling tasks and sub-tasks necessary for completion of a work project 128. Although information for individual identifiable workers can also be stored in database systems 102, utilizing worker types allows for more generic scheduling that does not rely upon particular worker details. Once the task and sub-task schedule has been created for worker types implementing a given work project 128, individual workers can then be assigned to cover the worker types based upon their fit to the skills needed for the worker types. It is contemplated, therefore, that each worker type represents or has associated with it a particular worker skill set and then that each worker type is assigned a series of tasks and sub-tasks for the project. It is these tasks and sub-tasks that are then tracked by the system.

The information being displayed through display systems 112 can be configured and selected, as desired, to provide status information useful to the workers and the managers engaged in the work project 128. The displayed information can also be adjusted by user-selected controls, such as user-selected time periods. For example, a user could select whether to see status information based upon by-day, by-week, or by-month time periods. The user can also select whether to view task level information or move down into sub-task level information. Thus, the user has great freedom to view relative completion level information based up tasks, sub-tasks, and time period. For example, a user could select a task and ask to view more detailed information concerning that task. Once the task is selected, the sub-tasks for that tasks can then be displayed along with the status information for those sub-tasks. If the sub-tasks further have sub-tasks, then they can also be individually selected for viewing of the sub-tasks within the sub-task, and so on in a nested hierarchical relationship. When viewed as tasks or sub-tasks, the display information can include relative completion levels that indicate a percentage completion for each task based upon a number of completed sub-tasks out of a total number of sub-tasks for the task or sub-task. The present invention, therefore, provides great flexibility in viewing and obtaining status information at desired levels of granularity. Other user selectable options can also be provided, as desired.

The data within the database systems can also be utilized by the real-time workload tracking system to generate a project schedule. For example, project data (PROJ) 106 can include tasks and sub-tasks that need to be completed and skills required for those tasks. Worker data (WKR) 104 can include worker type data where each worker type has a defined skill set. Using this project data (PROJ) 106 and worker data (WKR) 104, the real-time workload tracking system 100 can be used to create a project schedule that includes a detailed listing of tasks per-worker-type that must be conducted in order to complete the work project. The real-time workload tracking system 100 can also allow user manipulation of the generated project schedule. After creation of a project schedule that includes a list of tasks for each worker type designated, the schedule can be put into use at the work site for the work project 128. As discussed above, this allows the workers, managers, etc. involved in the project or in review of the project to have real-time information displayed at the project work site concerning project status, held-for information, and discrepancy record information.

FIG. 2 is a block diagram of an example embodiment 200 for utilizing an enterprise operations database 202 as part of the present invention. An enterprise operations database 202 can be an enterprise-wide system for operations, such as collaborative operations systems available from SAP. The enterprise operations database 202 can receive enterprise data updates 206 and can provide data 204 to other enterprise operations. The workload database systems 102 can periodically pull information and updates from the enterprise operations database 202 as represented by link 130A. The workload database systems 102 can also be updated through project updates 130B and through control and feedback data from link 110 to the workload system.

FIG. 3 is a process flow diagram 300 for updating database information as part of the real-time workload tracking system according to the present invention. Box 304 represents real-time updates to the workload database that can be caused by enterprise updates 302A, project updates 302B and workload updates 302C. From block 304, block 306 is reached where updates are loaded into the real-time tracking system. Finally, status displays are updated in block 308. Thus, updates to the database systems 102 can occur through a variety of processes, as desired. The updates can come from workload status updates through feedback from workers as to the progress in completing tasks and sub-tasks. Updates can come from modifications to the enterprise operations database and periodic updates to the database systems 102 from those enterprise updates. Updates can also come from changes to the nature or needs of the work project itself through project updates. In short, the data within the database systems 102 from which the real-time workload tracking system pulls to generate status displays can be updated in a wide variety of ways, as desired, for the particular implementation being utilized.

FIG. 4. is a process flow diagram for held-for record generation 400 according to the present invention. In block 402, a held-for record is created. In block 404, the held-for record is sent to the system and the database is updated. In block 406, a held-for indicator is displayed as part of the status displays. If desired, a notification is then sent, for example, by e-mail, in block 408. Held-for information is information that identifies what is holding up a particular task or sub-task from being completed. As such, held-for information can be a wide range of items. For example, a held-for record can be created when a particular tool or other resource is needed to move forward with a task or sub-tasks. A held-for record can be created when a certification or approval is required by a particular person or entity before anything else can be done. In short, any desired item that is holding up progress on the task of sub-task can be identified through the held-for generation process.

As part of this held-for processing, additional information and/or links can be provided through display systems. For example, a held-for link can be associated with each task for which a sub-task has held-for information associated with it. This held-for link can be a graphical icon or other identifiable link that when selected can take the user to a display within which relevant held-for information is provided. As an additional feature, an electronic notification, such as a page or an e-mail, can be sent to a person or entity responsible for resolving a held-for resource need. Thus, when a held-for record is generated as provided feedback data through the input mechanisms to the server system, an electronic notification can be sent to the relevant entity that needs to take action. To facilitate this process, when the held-for record is generated, for example, a field can be provided into which the record creator can input held-for contact information thereby identifying who should receive electronic notifications at the same time the held-for details are input as feedback into the system. In this way, where the held-for record relates to an action that must be taken by a person or group, the person or group will be notified that their action is now needed. One such example is where a certification or review must be accomplished by a particular person or group before work can continue.

FIG. 5 is a process flow diagram for discrepancy record generation 500 according to the present invention. In block 502, a discrepancy record is created. In block 504, the discrepancy record is sent to the system and the database is updated. In block 506, a discrepancy record indicator is displayed as part of the status displays. Discrepancy record information identifies problems identified during a task of sub-task. As such, discrepancy records can be a wide range of items. For example, a discrepancy record can be created when flaw or process error was noted during work on at task or sub-task. Such items could be damage or problems noted with respect to the thing be produced or processed. Where the work project is aircraft maintenance, for example, damage noted with respect to aircraft wing or fuselage structures could be noted in a discrepancy record. In short, any desired item that is an anomaly or problem associated with the task of sub-task can be identified through the discrepancy record generation process.

As with held-for records, as part of this discrepancy record processing, additional information and/or links can be provided through display systems. For example, a discrepancy report link can be associated with each task for which a sub-task has held-for discrepancy information associated with it. This discrepancy report link can be a graphical icon or other identifiable link that when selected can take the user to a display within which relevant discrepancy report information is provided. Again, as with held-for records, an electronic notification, such as a page or an e-mail, can be sent to a person or entity responsible for resolving or addressing a discrepancy report issue. Thus, when a discrepancy report is generated as provided feedback data through the input mechanisms to the server system, an electronic notification can be sent to the relevant entity that needs to take action. To facilitate this notification process, when a discrepancy record is generated, for example, a field can be included into which the record creator can input discrepancy contact information thereby identifying who should receive electronic notifications at the same time the discrepancy details are input as feedback into the system.

FIG. 6A is an example depiction 600 for display information showing per-worker progress in completing a workload project. The project task status for a first worker or first worker type (WRK1) is represented by horizontal bar 602. The project task status for a second worker or second worker type (WRK2) is represented by horizontal bar 604. The project status for a third worker or third worker type (WRK3) is represented by horizontal bar 606. And the project task status for a fourth worker or fourth worker type (WRK4) is represented by horizontal bar 608. The T0, T1, T2, T3, T4, T5, T6 designations represent time intervals, such as days or weeks or months. As indicated above, the time period displayed may be selectable by the user, if desired, depending upon the time periods desired to be viewed. Discrepancy records (DRs) are represented by elements 610A, 610B and 610C. Held-fors (HRs) are represented by elements 612A and 612B. In addition, S(N) represents the start of the worker task. E(N) represents the projected end of the work task. And P(N) represents the present status for the worker. The horizontal lines represent the portion of a task that is remaining to be done. The cross-hatches represents the portion of a task that has been completed. In addition, an area 605 can be reserved and used in the display to provide labor performance index (LPI) including various performance indicators, as described in further detail below.

It is noted that in one preferred embodiment, the representation of amount of work completed represents a percentage of completion. In particular, for example, the cross-hatches can be displayed such that they proportional cover the amount of the total task that relates to the percentage completion for that task. In addition, if desired, the actual percent completion numbers can be displayed, as well. The percent completion determinations can be made using any of a variety of techniques, as desired. One way of setting the percentage completion is by determining percentage completion by determining how many of the sub-tasks have been completed for a task (or sub-task) compared to the total number of sub-tasks for the task (or sub-task). However, this technique may not be particularly accurate where a number of sub-tasks are nearly compete but none are yet complete. Alternatively, therefore, the percentage completion for each sub-task can be combined together as a indicator of the completion percentage for the whole task. It is further noted that other techniques for determining completion levels could also be used, and other completion level indicators could be utilized depending upon the information desired to be displayed.

As indicated above, with respect to the schedule 600, the workers may originally be worker types as opposed to specifically identified people. Individual workers may then be identified for that worker type, if desired. It is also noted that the overall work task represented by the start task and end task indicators will typically include a number of sub-tasks that are to be accomplished by the worker type. Looking at worker 1 (WKR1) and the project status bar 602, the first start indicator (S1) represents the scheduled beginning of the overall task to be completed by WRK1. The first end indicator (E1) represents the projected or scheduled end of the overall task to be completed by WRK1. As contemplated herein, the overall project task for WRK1 will likely be made up of a number of different sub-tasks. Each of the sub-tasks in turn could be made up of a number of additional sub-tasks, and so on. In this way, a hierarchical task and sub-task organization is achieved that allows the real-time workload tracking system 100 to achieve any desired level of work task granularity. At the highest hierarchy, therefore, the first present status indicator (P1) indicates a completion level (e.g., percentage completion) for overall project task to be completed by the first worker type (WRK1), and the end indicator (E1) represents when the overall project task should be completed. As the user selects to go down into the task/sub-task hierarchy and view completion information at lower levels, this same or similar information can be displayed at each sub-task level. As depicted, the sub-tasks levels would be identifying task information being conducted by a single worker or worker type. Using this hierarchical structure, therefore, a manager or worker can view exactly what the worker should be accomplishing each hour, each day, each week, each month, etc. according to the projected start and end indicators for the schedule.

Looking in more detail to FIG. 6A, as indicated, the worker actually doing the tasks and sub-tasks for WRK1 has identified a discrepancy between T0 and T1. The worker has entered feedback into the system to identify discrepancy record information. As such, a discrepancy record link (DR) 610A is displayed between T0 and T1 on project status bar 602. Similarly, the worker doing the tasks and sub-tasks for WRK1 has identified a held-for issue between T1 and T2. The worker as entered feedback into the system to identify held-for record information. As such, a held-for record link (HF) 612A is displayed between T1 and T2 on project status bar 602. With respect to project status bar 606, two discrepancies have been reported, one between T1 and T2 as represented by discrepancy report link (DR) 610B and another between T2 and T3 as represented by discrepancy report link (DR) 610C. With respect to status bar 608, a held-for record has been reported between T3 and T4 as represented by held-for report link (HF) 612B. It is noted that any number of held-for reports and discrepancy reports can be reported into they system. It is also noted that other display link techniques could be used if desired. For example, a single link can be provided for the whole schedule 600 that takes a user to held-for and/or discrepancy information, or a single link for each status bar could be provided. This alternative could be used, for example, where it is not desired to clutter the screen with numerous graphical links.

Additional information can also be provided as part of the display information provided as part of the system of the present invention. Additional example information includes labor performance information, daily assigned employee information, and flow-down documentation techniques. Other features could also be added, if desired, while still taking advantage of the workflow system of the present invention.

With respect to labor performance, for example, a dynamic labor performance index (LPI) can be utilized to show at a glance, as part of the display information, how the tasks and sub-tasks are being performing with respect to planned or budgeted hours. As shown in FIG. 6A, an area 605 can be reserved for display of this LPI information. For example, the percentage of effort completed can be displayed along with the percentage of our hours used so far to reach that level of completion. In addition, font color and/or some other graphical indication can be utilized to provide an immediate visual indication of labor performance. For example, the fonts can be color coded to quickly show how the project is doing with respect to budgeted hours, such as green color for better than budget, yellow over budget but within a selected threshold, and red for over budget and past the threshold. In addition, the labor performance index can show the variance between planned hours and total actual hours used. Other performance criteria could also be analyzed and displayed, as well. The following is an example for the information that can be provided:

| | Example | |
|---|---|---|
| Parameter | Value | Comments |
| Performance to | 201% | Provides an indication of a percentage |
| Budget/Hours | <RED | over or under budget. Depending upon |
| | COLOR> | the value, the font color can change to |
| | | give an immediate visual indication of |
| | | the performance state. As indicated, |
| | | the font color would be red because |
| | | the hours used so far is significantly |
| | | over budget hours. |
| Effort Completed | 31.7% | Provides an indication of the |
| | | percentage of the job that has been |
| | | completed. |
| Hours Used | 63.7% | Provides an indication of the |
| | | percentage of the budgeted hours used |
| | | to date. |

In addition, other information can be provided. For example, the names of the employees that are currently clocked in to each sub-task can be provided. In addition, the actual planning ticket associated with that task can also be shown through a simple selection box provided within the display information. Further, flow-down functionality can be provided that allows employees to document or make notes that relate to specific tasks or sub-tasks. This information can then be provided to the employees that come in behind them to complete the tasks or sub-tasks thereby serving as an information flow-down process for the project.

FIG. 6B is an example depiction for display information showing status for sub-tasks within a given worker task. As depicted, for task (TASK 1) 650, there are four sub-tasks. The line 660 represents a fourth sub-task (SUB-TASK 1.4). The amount of progress achieved for sub-task 1.4 is none in this example. Line 658 represents the status of third sub-task (SUB-TASK 1.3). The amount of progress achieved for sub-task 1.3 is indicated by box 659. Line 656 represents the status of second sub-task (SUB-TASK 1.2). The amount of progress achieved for sub-task 1.2 is indicated by box 657. Line 654 represents the status of first sub-task (SUB-TASK 1.1). The amount of progress achieved for subtask 1.1 is indicated by box 655. The overall task is represented by line 652, and the overall progress achieved in completing this task is represented by box 653. As indicated above, the progress completion levels can represent the amount of progress completed using sub-task completion as an indicator. Each of the sub-tasks in FIG. 6B could in turn have a number of sub-tasks associated with it. The boxes 655, 657 and 659, therefore, can represent the portion of sub-tasks completed for that particular sub-task. If there are no sub-tasks for a particular sub-task, then the completion indication can be set to “nothing done” or “completed” levels (e.g., 0 percent or 100 percent completion). And as discussed above, a variety of techniques could be utilized to determine the percent completion levels for a given sub-task or group of sub-tasks.

The following EXAMPLE provides a further example for the task/sub-task hierarchical structure.

EXAMPLE - TASK/SUB-TASK
HIERARCHICAL STRUCTURE

EMPLOYEE TYPE

TASK 1

SUB-TASK 1.1
SUB-TASK 1.2
SUB-TASK 1.3

TASK 2

SUB-TASK 2.1
SUB-TASK 2.2
SUB-TASK 2.3

TASK 3

SUB-TASK 3.1
SUB-TASK 3.2

ETC.

In this example, TASK 1 has three sub-tasks. TASK 2 has three sub-tasks. TASK 3 has two sub-tasks, etc. In this example, the top level task is designated as a single integer and each sub-task is designated as a “.N” where “N” represents an integer. Thus, as depicted, the hierarchical nesting of the tasks/sub-tasks are related through these integers and periods. As discussed above, for each of these levels, start, end and completion level information can be provided for display based upon user selections. And for each of these levels, a worker and/or manager can provide real-time feedback as to completion status, held-for information, and discrepancy information to allow the real-time workload management system of the present invention provide and display real-time status information.

Thus, utilizing this hierarchical structure, tasks and sub-tasks can be assigned and set forth in the overall project schedule, as desired. And project status can be determined by the completion of sub-tasks. It is further noted that tasks for a particular work type can be designated to occur with respect to each other sequentially or concurrently or both. In addition, tasks can be identified for a particular worker type rather than being generically available for selection and completion.

In operation, therefore, the present invention provides a number of advantages. Unlike a waterfall approach where any person performs the next available task for a project, the system of the present invention enables each individual to have a pre-determined set of tasks from the beginning of the project to the end of the project. One benefit of this approach is that it facilitates accelerated learning curves because each individual does a repetitive set of tasks, enabling him to learn from his previous experiences. The present invention also allows for individual workers to be correlated to the specific work tasks. In this way, the supervisor will know that all tasks are covered and ties the task to an individual for any future references. The aspect of the present invention also lets the production worker know what is expected of him to get completed each day. In other words, the projected completion information provides the worker an indication of what should be done by each time period.

In addition, as opposed to simply providing a current status indication for progress (for example, not started, in progress, or complete), the system of the present invention displays the actual percentage complete for each task based on the confirmations of the operations input by project workers. The benefit of this approach includes allowing supervisors to know exactly where the production worker is at any point in time for each task, down to the operation level, and to determine a more accurate estimation to completion. Rather than simply track overall tasks for each worker, the present invention also tracks progress based upon sub-tasks, thereby providing a more efficient and accurate tracking of work being performed by the production workers. Still further, the advantage of real-time depictions of task status allows supervisors and workers to know at any given point in time the exact progress being made and any changes associated with the current tasks. This approach, therefore, makes schedule sliding more visible at an earlier stage in the production process. The present invention also provides status in graphical format. This graphical depiction allows views to be quick and easy to read in order for the persons using it to get the information digested quickly so that any potential issues can be identified.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A workload management system for production operations, comprising:
a database system configured to store data representing information relating to a plurality of tasks to be performed with respect to a production project and a plurality of worker resources available for completing the tasks, each task being configured to include a plurality of sub-tasks;
one or more input mechanisms configured to receive feedback data concerning the production project including completion status information for sub-tasks, held-for information identifying one or more resources needed to complete a particular sub-task, and discrepancy report information identifying problems associated with a particular sub-task; and
a server system coupled to the database and to the input mechanisms, the server system being configured to utilize data from the database system and feedback from the input mechanisms to display real-time status information for a relative completion level for each of the tasks based upon the completion status for the sub-tasks, to display a link to access held-for information, and to display a link to access discrepancy report information.

2. The workload management system of claim 1, wherein the plurality of tasks represent job tickets for aircraft maintenance.

3. The workload management system of claim 1, wherein the worker resources comprise one or more worker types, each worker type being configured to designate a particular worker skill set.

4. The workload management system of claim 1, wherein the worker resources comprise individually identified persons.

5. The workload management system of claim 1, wherein the database system comprises a first database periodically updated with information from an enterprise operations database.

6. The workload management system of claim 5, wherein the enterprise operations database comprises an SAP database.

7. The workload management system of claim 1, wherein the server system is further configured to display status information according to a user-selected time period.

8. The workload management system of claim 7, wherein the user-selected time period comprise by-week displays and by-month displays.

9. The workload management system of claim 1, wherein the server system is further configured to display real-time status information for a relative completion level for the sub-tasks associated with the tasks.

10. The workload management system of claim 9, wherein the server system is configured to display the sub-task status information for a particular task upon user selection.

11. The workload management system of claim 1, wherein a held-for link is associated with each task for which a sub-task has held-for information associated with it, and wherein a discrepancy report link is associated with each task for which a sub-task has discrepancy report information associated with it.

12. The workload management system of claim 1, wherein the server system is further configured to send an electronic notification to an entity responsible for resolving held-for resource needs when a held-for information is provided as feedback data through the input mechanisms to the server system.

13. The workload management system of claim 1, wherein the server system is further configured to generate a project schedule based upon information with the database system and to allow user manipulation of the generated project schedule.

14. The workload management system of claim 1, wherein the relative completion levels indicate a percentage completion for each task based upon a number of completed sub-tasks out of a total number of sub-tasks for the task.

15. The workload management system of claim 1, wherein the system is further configured to display labor performance information indicating actual completion status versus budgeted hours.

16. The workload management system of claim 15, wherein the system is further configured to display the labor performance information with a different visual indication depending upon whether performance is under or over budget.

17. A method for workload management of production operations, comprising:
storing in a database system data representing information relating to a plurality of tasks to be performed with respect to a production project and a plurality of worker resources available for completing the tasks, each task being configured to include a plurality of sub-tasks;
receiving feedback data concerning the production project including completion status information for sub-tasks, held-for information identifying one or more resources needed to complete a particular sub-task, and discrepancy report information identifying problems associated with a particular sub-task; and
displaying real-time status information for a relative completion level for each of the tasks based upon the completion status for the sub-tasks, to display a link to access held-for information, and to display a link to access discrepancy report information.

18. The method of claim 17, wherein the plurality of tasks represent job tickets for aircraft maintenance.

19. The method of claim 17, wherein the worker resources comprise one or more worker types, each worker type being configured to designate a particular worker skill set.

20. The method of claim 19, further comprising identifying worker as individual persons.

21. The method of claim 17, wherein the database system comprises a first database and further comprising periodically updating the first database with information from an enterprise operations database.

22. The method of claim 17, further comprising displaying status information according to a user-selected time period.

23. The method of claim 22, further comprising allowing a user to select at least a by-week display and a by-month display.

24. The method of claim 17, further comprising displaying real-time status information for a relative completion level for the sub-tasks associated with the tasks.

25. The method of claim 24, further comprising displaying the sub-task status information for a particular task upon user selection.

26. The method of claim 17, further comprising associating a held-for link with each task for which a sub-task has held-for information associated with it and associating a discrepancy report link with each task for which a sub-task has discrepancy report information associated with it.

27. The method of claim 17, further comprising sending an electronic notification to an entity responsible for resolving held-for resource needs when a held-for information is provided as feedback data through the input mechanisms to the server system.

28. The method of claim 17, further comprising generating a project schedule based upon information with the database system and allowing user manipulation of the generated project schedule.

29. The method of claim 17, wherein the relative completion levels indicate a percentage completion for each task based upon a number of completed sub-tasks out of a total number of sub-tasks for the task.

30. The method of claim 17, further comprising displaying labor performance information indicating actual completion status versus budgeted hours.

31. The method of claim 30, further comprising displaying the labor performance information with a different visual indication depending upon whether performance is under or over budget.
